(19) United States
(12) Patent Application Publication
(10) Pub. No.: US 2022/0369613 A1
(43) Pub. Date: Nov. 24, 2022

(54) FISHING LURES

(71) Applicant: A Band of Anglers Inc., Lake Wales, FL (US)

(72) Inventor: Patrick Sebile, Lake Wales, FL (US)

(21) Appl. No.: 17/862,643

(22) Filed: Jul. 12, 2022

Related U.S. Application Data
(63) Continuation of application No. 16/864,974, filed on May 1, 2020, now abandoned.
(60) Provisional application No. 62/843,793, filed on May 6, 2019.
(60) Provisional application No. 62/841,625, filed on May 1, 2019.

(51) Int. Cl. A01K 85/00; A01K 91/04

(52) U.S. Cl. CPC A01K 85/00; A01K 91/04

(57) ABSTRACT

A lure can include a lure body. The lure body can define one or more complimentary apertures that can have a complimentary shape to at least a portion of a hook structure and can be configured to receive within and to compliment the shape of at least a portion of the hook structure.

### CROSS-REFERENCE TO RELATED APPLICATIONS

This application is a continuation of U.S. patent application Ser. No. 16/864,974, filed May 1, 2020, which claims priority to and the benefit of U.S. Provisional Application No. 62/841,625, filed May 1, 2019, and U.S. Provisional Application No. 62/843,793, filed May 6, 2019, the entire contents of which are herein incorporated by reference in their entirety.

### BACKGROUND

This application relates to fishing, e.g., fishing lures and components therefor. Conventional lures and components have generally been considered satisfactory for their intended purpose. However, there is still a need in the art for improved lures. The present disclosure provides a solution for this need.

### SUMMARY

A lure can include a lure body. The lure body can define one or more complimentary apertures that can have a complimentary shape to at least a portion of a hook structure and can be configured to receive within and to compliment the shape of at least a portion of the hook structure.

The one or more complimentary apertures can include one or more anchorage apertures configured to receive one or more barbs extending from a barb body of the hook structure. The one or more anchorage apertures can extend transverse to a length and a width of the lure body.

The one or more complimentary apertures can include one or more barb body apertures defined adjacent to the anchorage apertures. The one or more barb body apertures can include a conical shape. In certain embodiments, the one or more complimentary apertures can include two complimentary barb body apertures, and the one or more anchorage apertures can include two anchorage apertures, each adjacent to a respective barb body aperture. Any other suitable number of complimentary apertures (e.g., one, two, three, or more) are contemplated herein.

The lure can include a hook channel. The hook channel can be defined longitudinally in the lure body through the barb body apertures. The hook channel can include a smaller diameter or other outer dimension that the one or more barb body apertures.

The lure can further include a back cut channel defining a planar space longitudinally and transverse to the width of the lure body. The back cut channel can be connected to the hook channel and configured to receive a hook portion of the hook structure and to allow the hook portion to extend outwardly from the lure body.

In certain embodiments, the lure body can define an exact negative space for the entire positive structure of the hook structure. Any suitable amount of complimentary negative structure is contemplated herein.

In certain embodiments, the lure can include the hook structure disposed within the lure body. The hook structure can include one or more barbs, each barb extending laterally from a respective barb body into a respective anchorage aperture of the one or more anchorage apertures.

In certain embodiments, each barb body can be shaped to be compressed by the lure body to urge the barb body in a longitudinal direction to contact and/or compress each barb against a wall defining each anchorage aperture. However, in certain embodiments, each barb body can be sized to fit snugly within a predefined barb body aperture of a complimentary shape.

In certain embodiments, each barb body can include a conical shape. The conical shape can widen away from a hook portion of the hook structure such that the lure body urges the hook upward. Any other suitable shape is contemplated herein. The lure body can define any suitable fishing lure shape.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1A shows an embodiment of the a soft lure in accordance with this disclosure;

FIG. 1B shows an embodiment of a connector for the soft lure of this disclosure;

FIG. 2A shows an embodiment of the a soft lure in accordance with this disclosure;

FIG. 2B shows an embodiment of a connector for a soft lure of this disclosure;

FIG. 3A shows an embodiment of the a soft lure in accordance with this disclosure;

FIG. 3B shows an embodiment of a connector for a soft lure in accordance with this disclosure;

FIG. 4 is a comparison diagram of force distribution on a cylindrical gripping portion A and two embodiments of a gripping portion B and C in accordance with this disclosure;

FIGS. 5A-E show an embodiment of a lure having a back cut along a length of the lure;

FIGS. 6A and 6B show an embodiment of a lure having a secure grip configuration;

FIGS. 7A-C show an embodiment of a swimming lure;

FIG. 8 shows an embodiment of a jointed weight for a fishing lure;

FIGS. 9A and 9B show an embodiment of a lure having belly ribs and side wings;

FIG. 9C shows a schematic diagram of an embodiment of belly ribs of FIG. 9A;

FIGS. 10A-10B show an embodiment of a shrimp lure;

FIG. 11 shows an embodiment of a worm lure; and

FIGS. 12A-12C show an embodiment of a hybrid lure.

### DETAILED DESCRIPTION

Reference will now be made to the drawings wherein like reference numerals identify similar structural features or aspects of the subject disclosure. For purposes of explanation and illustration, and not limitation, an illustrative view of one or more embodiments in accordance with the disclosure are shown in the figures and is designated generally by reference characters described below. The embodiments disclosed herein can be used for any suitable purpose, e.g., fishing.

Soft lures can include a rigid connector that tends to damage the soft lure material in use and tend to rip and/or break the soft lure material. The connection of the lure to the connector can thus be a weak point of the assembly.

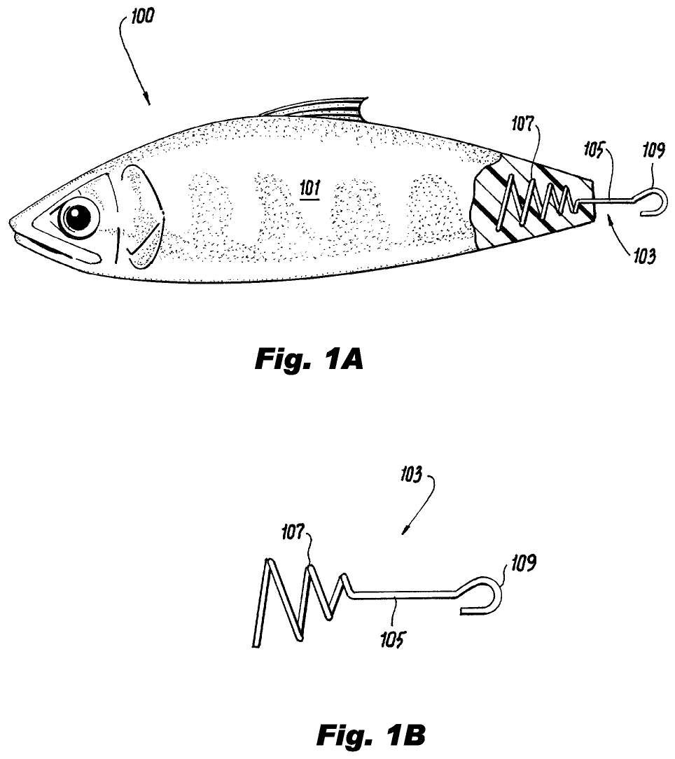

Referring to FIGS. 1A and 1B, a lure 100 can include a flexible lure body 101 and a connector 103. The lure body 101 can be made of any suitable material as appreciated by those having ordinary skill in the art (e.g., a plastic, rubber, or any suitable soft, elastic, and/or resilient material). The connector 103 can be made of metal (e.g., stainless steel) or any suitable rigid material (e.g., hard plastic, ceramic).

The lure body 101 can have any suitable shape. The connector 103 can include a shape configured to increase gripping surface area within the lure body 101. For example, the connector 103 can include a stem 105 and a gripping portion 107. The stem 105 can be configured to extend from the lure body 101 and can include a loop 109 (e.g., a hook or circle) at an end opposite the gripping portion 107 for connecting to any other suitable item (e.g., a spinner blade).

The gripping portion 107 can be a wound section of the connector 103 as shown. The wound section can include a non-uniform winding radius (e.g., in an axial direction, left-right axis shown in the drawings). For example, as shown in FIGS. 1A and 1B, the winding radius can increase toward the end of the gripping portion 107 (e.g., toward the center of the lure body 101). The change in winding radius can be constant or variable and/or linear or non-linear over the length of the gripping portion 107.

For example, a conic shape gripping portion 107 (e.g., a wire that is wound to form a conic shape) can have a better grab into the plastic than a cylindrical one, as forces will apply on a bigger surface and have more material to build up resistance to pulling pressure, making the insert much more long lasting than if wire just spooled as a circular spring. Holding into a soft plastic part can be much better, stronger, and longer lasting because giving the spring a conic shape gives more pulling area. A conic spring shape, e.g., adapted to the shape of the part where its insert can be positioned in the mold before molding.

In certain embodiments, the gripping portion 107 can be shaped to at least partially follow the shape of the lure body 101. For example, as shown in FIGS. 1A and 1B, the winding radius in at least one dimension can increase with an increase in width and/or thickness of the lure body 101. In certain embodiments, it is contemplated that the gripping portion 107 can terminate in a middle of the lure body 101.

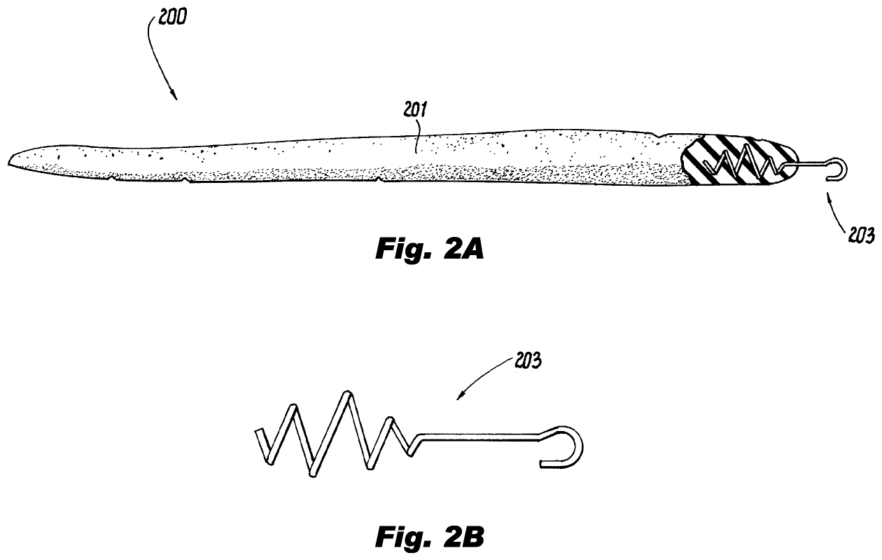

FIGS. 2A and 2B show another embodiment of lure 200 having a lure body 201 and connector 203 having a different shape than that of the embodiment of FIGS. 1A and 1B. As can be seen, the connector 203 includes a non-constant winding radius that increases then decreases.

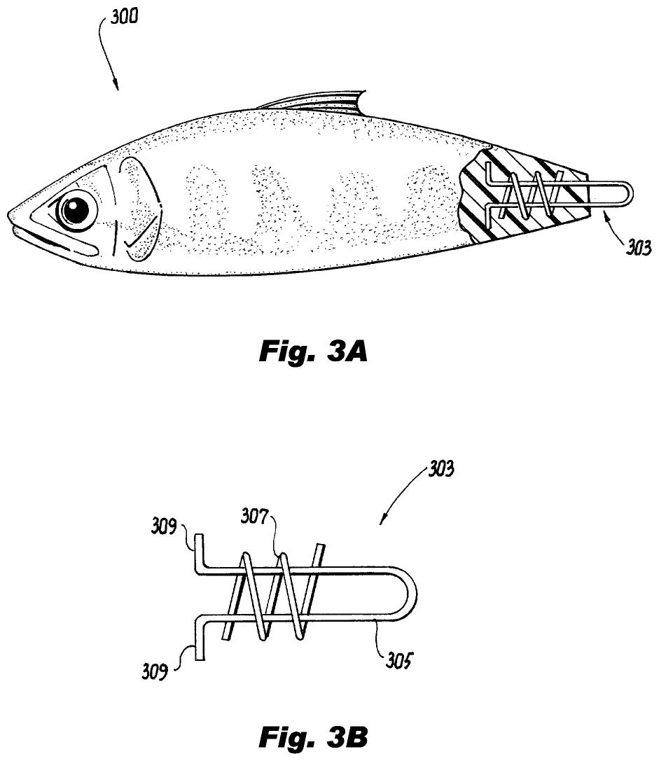

FIGS. 3A and 3B show another embodiment of lure 300 having a lure body 301 and connector 303 having a different shape than that of the embodiment of FIGS. 1A-2B. As can be seen, the connector 303 includes double wire loop shape 305 and a gripping portion 307 (e.g., a wound section similar as described above) disposed around the double wire loop shape 305. The connector 303 can include one or more feet 309 at the end of the double wire loop shape 305. As shown, a portion of the double wire loop shape 305 can extend from lure body 301 to form the connecting loop (e.g., to attach a spinner blade to).

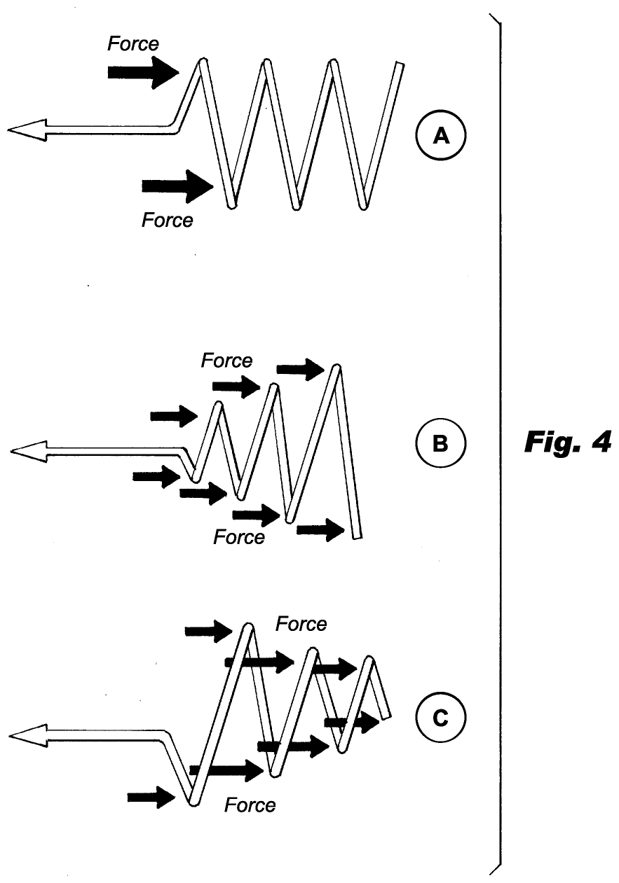

FIG. 4 is a comparison diagram of force distribution on a cylindrical gripping portion A and two embodiments of a gripping portion B and C in accordance with the above. As can be seen, more surface area is present to generate a better gripping force in embodiments B and C.

Any other suitable shaped lure is contemplated herein. Any other suitable shaped connector is contemplated herein.

Soft plastic lures, for example, have a range of possibilities and action, but adding parts, appendices, elements, or anything that can create more attraction to the bait is always limited by the fact that the soft material used won't hold the added component very well. It results in lures not lasting long, being cut/torn apart more quickly, and loss of the component. Also, adding a component does not always help to transfer most of the component's action to the soft plastic lure action itself, lowering the effect, impact, and efficiency of the addition.

Embodiments of connectors include a shape to hold onto a soft material well. Embodiments can be inserted in the mold and soft plastic material can be poured or injected after insertion of the connector in the mold. In certain embodiments, the specific shape of the connector can be related to the component(s) of the soft plastic material and also to the addition of the final attachment. This can enable a long lasting hold in the soft plastic lure for an elongated use of the lure by the angler, and also to optimize the type of action the attachment will have in order to translate some or all of this motion/energy to the lure to get more attention from the fish and ultimately to help catching more, and also bigger, fish.

Embodiments can make fishing faster, cheaper, and more worthwhile for the user. Embodiments can reduce pollution due to reduced loss of plastic lure bodies, for example. Certain other benefits are appreciated by those having ordinary skill in the art. Embodiments allow the lure to last longer because both of the shape of the gripping portion, and also because it can be inserted into the mold, not screwed in. Existing screw-ins are cylinder shaped screwing springs, so the angler can screw it where he wants into a soft plastics to add an external part such as a blade. But this weakens the soft body of the lure considerably, and does not give the best translation of vibrations between the external part such as a blade and the soft lure body. Embodiments outperform existing lures.

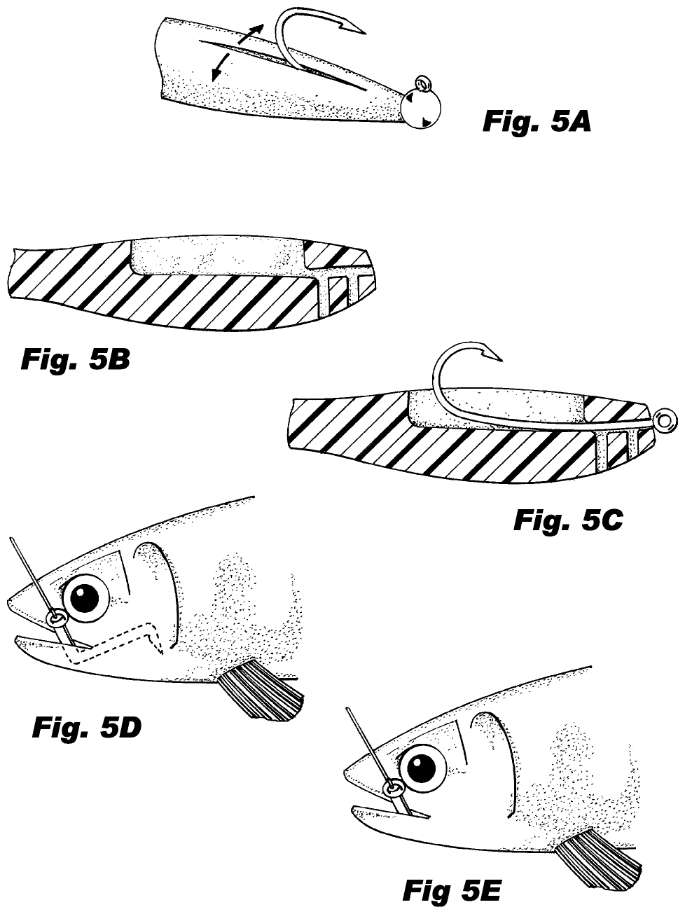

FIGS. 5A-E show an embodiment of a lure having a back cut along a length of the lure. The lure can include a deep cut in the back, starting roughly where the jighead hook barbs ends (e.g., a lead barb at the end of the hook shank configured to grab the). In certain embodiments, the depth can be about a fourth to about a half of the distance across the lure, for example. The depth can be deep enough or greater to reach the hook hole such that the hook shank can freely rest in the deep cut (e.g., so the hook can move and/or rotate out of the cut when pulled). Any other suitable length and/or depth is contemplated herein (e.g., to allow the bait to come out of the fish mouth after hooking. This avoids the soft lure body from being too stiff and gives it some up/down freedom of movement to get more lifelike and realistic movement from the lure body. Once a fish is hooked, in the case of a regular soft plastic that is on the hook shank, the fish can chew the lure during the fight. This gives more leverage (so there higher chance to unhook and lost the fish while fighting it) and also damages the lure body. Embodiments including a back cut, the lure will slide away sideways, leaving only the hook shank in fish mouth (so less leverage meaning less fish loss; lure outside of the fish mouth means less damage, so a longer lasting lure). The deep cut can also for a wider range of rigging for the lure, making it easy for example to pass a leader through the lure or its belly quite easily compared to a lure without such a cut.

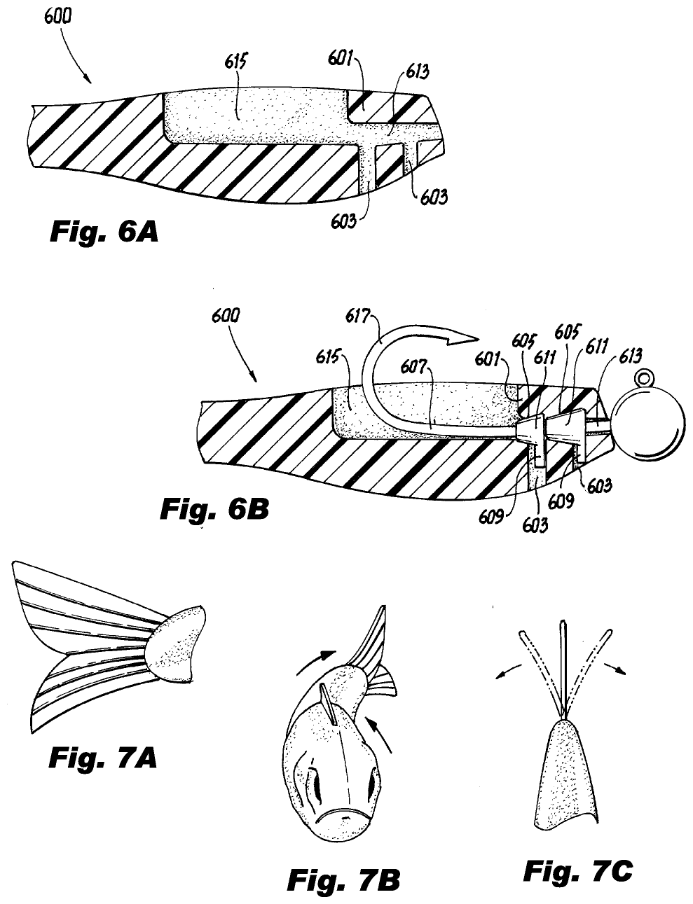

Referring to FIGS. 6A and 6B show an embodiment of a lure having a secure grip configuration. Typical jigheads and bucktails have one or several cones or shapes close to a cone to help holding the soft plastic body to be rigged on it. Some have one or several extra barbs to grab more into material. These have decent holding of the soft plastic lures, but it is not ideal and also damages the soft body.

Referring to FIGS. 6A and 6B, a lure 600 can include a lure body 601. The lure body 601 can define one or more complimentary apertures 601, 605 have a complimentary shape to at least a portion of a hook structure 607 and are configured to receive within and to compliment the shape of at least a portion of the hook structure 607.

The one or more complimentary apertures 601, 605 can include one or more anchorage apertures 601 configured to receive one or more barbs 609 extending from a barb body 611 of the hook structure 607. The one or more anchorage apertures 601 can extend transverse to a length (axis left and right as shown) and a width (axis into and out of the page) of the lure body 601, for example.

As shown in FIG. 6B, the one or more complimentary apertures 601, 605 can include one or more barb body apertures 605 (shown filled with barb bodies 611) defined adjacent to the anchorage apertures 601. The one or more barb body apertures 605 can include a conical shape. Any other suitable shape is contemplated herein. In certain embodiment, the one or more complimentary apertures 601, 605 can include two complimentary barb body apertures 605, and the one or more anchorage apertures 601 can include two anchorage apertures 601, each adjacent to a respective barb body aperture 605. Any other suitable number of complimentary apertures (e.g., one, two, three, or more) are contemplated herein.

The lure 600 can include a hook channel 613. The hook channel 613 can be defined longitudinally in the lure body 601 through the barb body apertures 605 (e.g., as shown in FIG. 6B). The hook channel 613 can include a smaller diameter or other outer dimension that the one or more barb body apertures 605, for example.

The lure 600 can further include a back cut channel 615 defining a planar space longitudinally and transverse to the width of the lure body 601. The back cut channel 615 can be connected to the hook channel 613 and configured to receive a hook portion 617 of the hook structure 613 and to allow the hook portion 617 to extend outwardly from the lure body 601 (e.g., as shown in FIG. 6B).

In certain embodiments, the lure body 601 can define an exact negative space for the entire positive structure of the hook structure 607. Any suitable amount of complimentary negative structure is contemplated herein (e.g., partial as shown for a neck portion of the hook structure 607 which can include the barb bodies and/or barbs).

In certain embodiments, the lure 601 can include the hook structure 607 disposed within the lure body 601. The hook structure 607 can include one or more barbs or keepers 609, each barb 609 extending laterally from a respective barb body 611 into a respective anchorage aperture 603 of the one or more anchorage apertures 603.

In certain embodiments, each barb body 611 can be shaped to be compressed by the lure body 601 (e.g., as shown in FIG. 6A) to urge the barb body 611 in a longitudinal direction to contact and/or compress each barb 609 against a wall defining each anchorage aperture 609. For example, it is contemplated that a smaller barb body aperture 605 than the barb body 611, or no barb body aperture 611, can be used which can cause a material compression and resulting biasing force against the hook structure 607 when inserted into the lure body 601 (e.g., which can be made of resilient, elastic material). However, in certain embodiments, each barb body 611 can be sized to fit snugly within a predefined barb body aperture 605 of a complimentary shape.

In certain embodiments, each barb body 611 can include a conical shape (e.g., as shown). The conical shape can widen away from a hook portion 617 of the hook structure 607 such that the lure body 601 urges the hook upward. Any other suitable shape is contemplated herein. The lure body 601 can define any suitable fishing lure shape (e.g., a bait fish, a shrimp, a worm, etc).

Compatible shapes can be disposed in both the lure (e.g., one or more barb holes) and on the jighead/bucktail/lure holder (e.g., one or more grips/barbs to fit into the one or more barb holes the soft plastic to give a maximum holding power). The lure can be slipped onto the hook/lure holder, and pulling the lure sideways where the barb hole(s) is/are can help sliding the body in the right position.

Embodiments of a lure body can include any suitable complimentary holes or apertures for a certain hook structure (e.g., barbs and/or a conical body shape) that receives the hook structure within. The lure body can include an exact or similar negative space for the entire positive structure of the hook structure or for a portion of the positive structure of the hook structure. Any suitable amount of complimentary shape is contemplated herein. In certain embodiments, the lure can include one or more anchorage apertures (e.g., two as shown) to receive one or more anchorage points from a hook structure (e.g., barbs as shown). Embodiments can include a lure assembly including the hook structure disposed within the lure body as shown. The lure body can include any suitable lure shape (e.g., a bait fish shape).

FIGS. 7A-C show an embodiment of a swimming lure. There are many soft swimming lures on the market. Some have no tail, some have a tail. Having a tail makes a lure look like a real baitfish. As swimmer types of soft lures are pulled, their apparent swim motion happens because of the water turbulence waves flowing on each sides of a lure. But a tail makes the lure lose some of this energy and movement, making the swim action less visual than it should be. Embodiments can have one or more lengthwise cuts in the tail. For example, as shown the tail can be cut into number of little long pieces such that under the retrieve, once the lure body starts to move into a swimming action, the tail produces much less water resistance and thus less loss of energy because each thin piece can move in any direction easily and water flows in between the pieces of tail. The result is a more visual swimming action that is more satisfying to the angler.

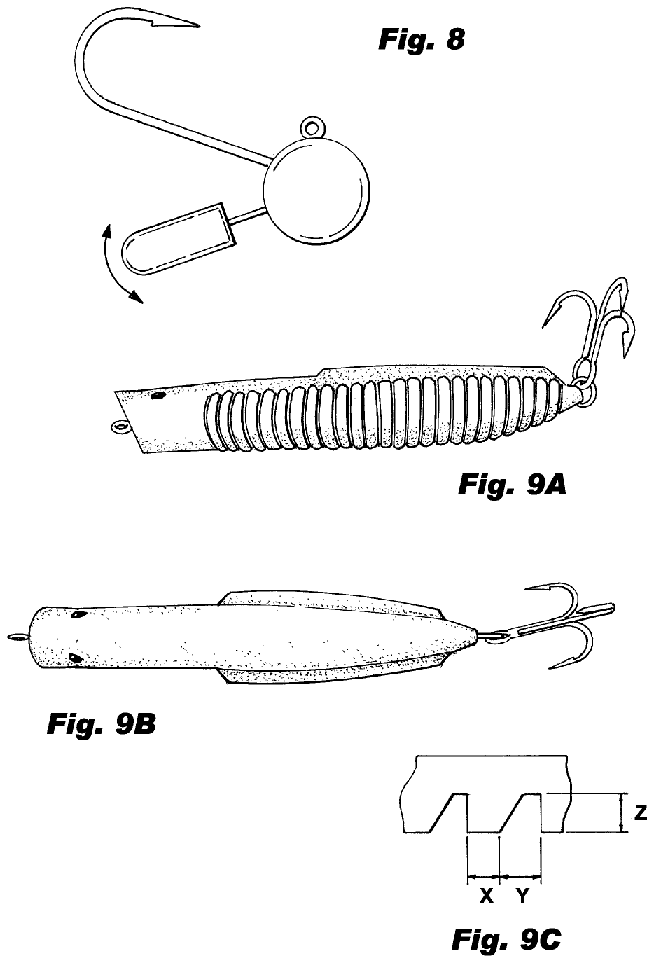

FIG. 8 shows an embodiment of a jointed weight for a fishing lure. On certain lures with a big fixed weight (e.g., in the lure), a problem encountered is that it makes a bulkier bite for a fish due the fixed rigid shape of the weight. This may cause the hook to not be well secured into the fish mouth when hooked and/or may reduce the incidence of hooking. Fish may be lost more frequently during the fight if hooked on traditional lures. In order to limit such risk for example, and for use for any other suitable purpose, a jointed weight, e.g., as shown in FIG. 4 or having any other suitable features, can allow to for the weight and lure to be compressed when the fish bites on the lure (e.g., chewing while hooked). Any suitable weight pieces (e.g., a plurality of metal pieces) and any suitable joint (e.g., wire, hinge, etc.) is contemplated herein. Embodiments can hook more fish and lose less fish.

FIG. 9A-9C show an embodiment of a lure having belly ribs and side wings. Certain embodiments may only include belly ribs and no side wings. Certain embodiment may only include side wings and no belly ribs. The belly ribs are configured to reduce air friction when the lure is cast to increase casting distance (e.g., similar to dimples on a golf ball). As shown, most of the belly of the lure can be covered in belly ribs. As shown in FIG. 5, the belly ribs can include a width x, separated by a gap distance y, and a depth of z as shown. The belly ribs can include any suitable shape (e.g., angled or curved on an upstream side as shown). In certain embodiments, the width x can be about 1% to about 5% of the total length of the lure. The width x can be about 40% to about 60% of the total length of the distance x+y. The gap distance can be about 40% to about 60% of the total length of the distance x+y. The depth z can be about the same dimension as the width x and/or about 40% to about 60% of the total length of the distance x+y. Any other suitable dimensions are contemplated herein. The side wings can be configured to act as a stabilizer and/or lifting surface in flight in air when being cast.

In certain embodiments the side wings can have an angle wing portion along a length of each side wing to aid in producing a desired pitch and/or lift in flight (e.g., to pitch up in flight in a hook forward flight direction), e.g., to reduce drag and/or to provide lift to increase cast distance. The side wings can also be configured to provide lift in the water when reeling the bait (e.g., to provide any desired directional control, e.g., to lift up toward the surface, to dive down deeper, or to stabilize at a constant depth). The side wings can also be configured to provide a desired swim action (e.g., shaking back and forth, for example). The side wings can have a length that is about 20% or greater than the total length of the lure. The side wings can have a thickness along its length that is constant or variable. The side wings can have a thickness of about 0.5% to about 10% of the total length of the lure. The extension laterally of the side wings can be about 5% to about 60% of the diameter or width of the lure at the portion including the side wings. The side wings can be sized and configured to deflect objects in the water to reduce snagging, for example. Any other suitable dimensions for the side wings are contemplated herein.

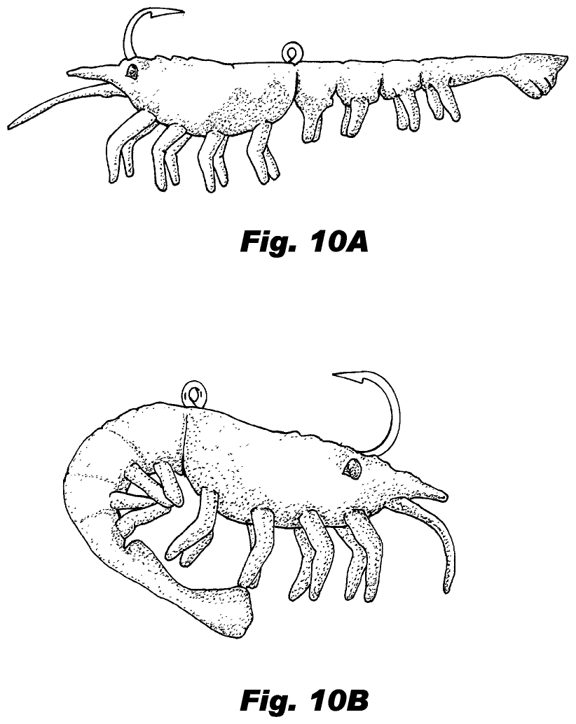

FIGS. 10A-10B show an embodiment of a shrimp lure. The shrimp lure can include a soft body (e.g., soft plastic). The lure can be shaped to have hinges similar to a shrimp tail to cause tail swimming action when pulled. The lure can include a hook placed or molded within the lure body such that the hook line attachment (e.g., the eyelet) is positioned at the shrimp head of the body at or before the first hinge of the tail section of the shrimp body as shown. This position causes the shrimp to have a fleeing swim action to mimic actual shrimp swimming action. The shrimp lure can also include a plurality of soft legs configured to mimic shrimp legs. The legs can be bent backward as shown to have a knee pointing forward which can simulate realistic movement of shrimp legs.

The shrimp lure can include a weight disposed within the head of the shrimp body. The weight can be disposed in any suitable position to cause any suitable sinking action (e.g., to simulate forward and/or sinking movement of a real shrimp). Embodiments of a shrimp lure can be configured for topwater tail popping. For example, embodiments of a shrimp lure can include specific body width for developing a water pressure on the lure that causes the lure to overcome the weight to cause the lure to tail pop with the weight facing down and the tail facing up. In such embodiments, the lure can include a shape, e.g., as shown, that allows rod tip twitch together with the right speed retrieve to create the tail topwater popping action such as a shrimp wanting to jump off of the water to escape a predator fish. For example, if the shrimp length is 10 cm the width of the shrimp can be about 1 cm (e.g., about a 1/10th ratio or wider) and the weight can be positioned and sized to cause the head of the shrimp lure to be down and the tail to be up at a typical slow to medium retrieve speed (e.g., under about 200 meters of line per minute) using a real in the range of 1000-5000. Any suitable shape and/or size for the lure and/or legs (e.g., relatively as shown) are contemplated herein.

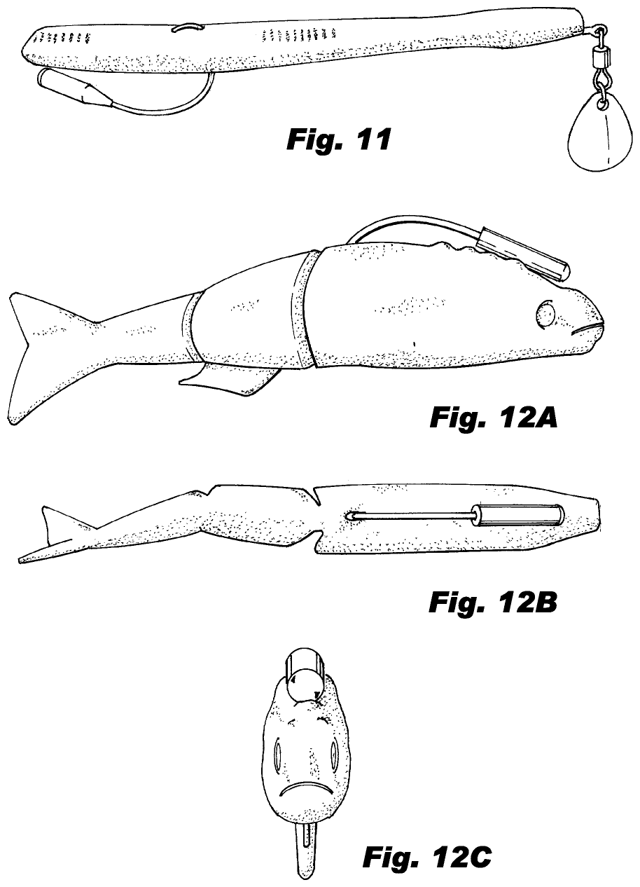

FIG. 11 shows an embodiment of a worm lure. The worm lure can be made of a soft material (e.g., soft plastic) and can be configured to have features, e.g., as shown, to provide better swimming action than existing worm lures. Certain embodiments of the worm lure can include a blade (e.g. a spinner blade) attached thereto, a flat top, a front weight attached to the hook as shown, and a back cut (e.g., as described above). Any other suitable features are contemplated herein.

FIGS. 12A-12C show an embodiment of a hybrid lure configured to have swimming action when being pulled and to have a dying action when allowed to float such that the lure will turn on its side and float upward to mimic a dying bait fish when pulling is ceased. Certain embodiments can include a hook that is lightly weighted or unweighted such that the weight is not enough to sink the lure and to allow the lure to turn on its side. The lure body can be made from buoyant material (e.g., TPR) and shaped such that when pulling is stopped, the lure turns on one or either side and floats upward. The hybrid lure can include a hinged tail and/or any other suitable feature to cause swimming action when being pulled. Any other suitable features are contemplated herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

Any suitable combination(s) of any disclosed embodiments and/or any suitable portion(s) thereof are contemplated herein as appreciated by those having ordinary skill in the art.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A lure, comprising:
a flexible lure body; and
a connector disposed partially within the flexible lure body, wherein the connector includes a shape configured to increase gripping surface area within the lure body, wherein the connector includes:
a stem; and
a gripping portion, wherein the gripping portion is a wound section of the connector, wherein the wound section can include a non-uniform winding radius.

2. The lure of claim 1, wherein the stem is configured to extend from the lure body and loop at an end opposite the gripping portion.

3. The lure of claim 1, wherein the winding radius increases toward the end of the gripping portion toward the center of the lure body.

4. The lure of claim 1, wherein a change in the winding radius is constant over the length of the gripping portion.

5. The lure of claim 1, wherein a change in the winding radius is variable over the length of the gripping portion.

6. The lure of claim 1, wherein a change in the winding radius is linear over the length of the gripping portion.

7. The lure of claim 1, wherein a change in the winding radius is non-linear over the length of the gripping portion.

8. The lure of claim 1, wherein the gripping portion is a wire that is wound to form a conic shape.

9. The lure of claim 1, the gripping portion is shaped to at least partially follow the shape of the lure body.

10. The lure of claim 9, wherein the winding radius in at least one dimension increases with an increase in width and/or thickness of the lure body.

11. The lure of claim 1, wherein the gripping portion includes a winding radius that increases then decreases toward an end of the gripping portion.

12. The lure of claim 1, wherein the gripping portion terminates in a middle of the lure body.

13. The lure of claim 1, wherein the lure body is made of a soft, elastic, and/or resilient material.

14. The lure of claim 13, wherein the connector is be made of a hard and/or rigid material.

15. A lure, comprising:
a flexible lure body; and
a connector disposed partially within the flexible lure body, wherein the connector includes:
a double wire loop shape; and
a wound gripping portion disposed around the double wire loop shape and disposed within the flexible lure body.

16. The lure of claim 1, wherein a portion of the double wire loop shape extends from lure body to form a connecting loop.

17. A lure, comprising;
a flexible lure body; and
connector means disposed partially within the flexible lure body for increasing gripping surface area within the lure body.
